(19) United States
(12) Patent Application Publication
(10) Pub. No.: US 2024/0022236 A1
(43) Pub. Date: Jan. 18, 2024

(54) ELECTRONIC CIRCUIT AND CALCULATOR

(71) Applicant: KABUSHIKI KAISHA TOSHIBA, Tokyo (JP)

(72) Inventors: Noritsugu SHIOKAWA, Yokohama Kanagawa (JP); Tamio KAWAGUCHI, Kawasaki Kanagawa (JP); Hayato GOTO, Kawasaki Kanagawa (JP); Taro KANAO, Kumagaya Saitama (JP); Yinghao HO, Kawasaki Kanagawa (JP)

(73) Assignee: KABUSHIKI KAISHA TOSHIBA, Tokyo (JP)

(21) Appl. No.: 18/171,943

(22) Filed: Feb. 21, 2023

(30) Foreign Application Priority Data
Jul. 15, 2022 (JP) 2022-114305

(51) Int. Cl. H03H 11/04; H01P 7/00; H03K 17/92; G06N 10/40

(52) U.S. Cl. CPC H03H 11/04; H01P 7/00; H03K 17/92; G06N 10/40

(57) ABSTRACT

According to one embodiment, an electronic circuit includes a band-pass filter, first circuits, a first port, and a second port. The band-pass filter includes filter resonators. Two adjacent filter resonators included in the filter resonators are mutually couplable. Each of the first circuits includes a first qubit and a first readout resonator. The first readout resonator is couplable with the first qubit. One of the filter resonators is couplable with the first readout resonator of one of the first circuits. Another one of the filter resonators is couplable with the first readout resonator of another one of the first circuits. The filter resonators include first, second, and third filter resonators. The first filter resonator is couplable with the first port. The second filter resonator is couplable with the second port. The third filter resonator is between the first filter resonator and the second filter resonator.

### CROSS-REFERENCE TO RELATED APPLICATIONS

This application is based upon and claims the benefit of priority from Japanese Patent Application No. 2022-114305, filed on Jul. 15, 2022; the entire contents of which are incorporated herein by reference.

### FIELD

Embodiments described herein relate generally to an electronic circuit and a calculator.

### BACKGROUND

For example, an electronic circuit that includes a qubit is used in a calculator. It is desirable to improve the characteristics of the electronic circuit.

### BRIEF DESCRIPTION OF THE DRAWINGS

FIG. 1 is a schematic view illustrating an electronic circuit according to a first embodiment;

FIG. 2 is a schematic view illustrating an electronic circuit according to a first reference example;

FIG. 3 is a schematic view illustrating an electronic circuit according to a second reference example;

FIG. 4 is a schematic view illustrating an electronic circuit according to the first embodiment;

FIGS. 5A and 5B are graphs illustrating characteristics of the electronic circuit according to the first embodiment;

FIG. 6 is a graph illustrating characteristics of the electronic circuit according to the first embodiment;

FIG. 7 is a schematic view illustrating an electronic circuit according to the first embodiment;

FIG. 8 is a schematic view illustrating an electronic circuit according to the first embodiment;

FIG. 9 is a schematic view illustrating characteristics of the electronic circuit according to the first embodiment;

FIG. 10 is a schematic view illustrating characteristics of the electronic circuit according to the first embodiment;

FIG. 11 is a schematic view illustrating an electronic circuit according to the first embodiment;

FIG. 12 is a schematic view illustrating an electronic circuit according to the first embodiment;

FIGS. 13A and 13B are graphs illustrating characteristics of the electronic circuit according to the first embodiment;

FIG. 14 is a schematic view illustrating characteristics of the electronic circuit according to the first embodiment;

FIG. 15 is a schematic view illustrating an electronic circuit according to the first embodiment;

FIG. 16 is a schematic plan view illustrating an electronic circuit according to the first embodiment;

FIGS. 17A and 17B are schematic cross-sectional views illustrating portions of the electronic circuit according to the first embodiment;

FIG. 18 is a schematic plan view illustrating an electronic circuit according to the first embodiment; and

FIG. 19 is a schematic view illustrating the calculator according to a second embodiment.

### DETAILED DESCRIPTION

According to one embodiment, an electronic circuit includes a band-pass filter, a plurality of first circuits, a first port, and a second port. The band-pass filter includes a plurality of filter resonators. Two adjacent filter resonators included in the plurality of filter resonators are mutually couplable. Each of the plurality of first circuits includes a first qubit and a first readout resonator. The first readout resonator is couplable with the first qubit. One of the plurality of filter resonators is couplable with the first readout resonator of one of the plurality of first circuits. Another one of the plurality of filter resonators is couplable with the first readout resonator of another one of the plurality of first circuits. The plurality of filter resonators include a first filter resonator, a second filter resonator, and a third filter resonator. The first filter resonator is couplable with the first port. The second filter resonator is couplable with the second port. The third filter resonator is between the first filter resonator and the second filter resonator.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

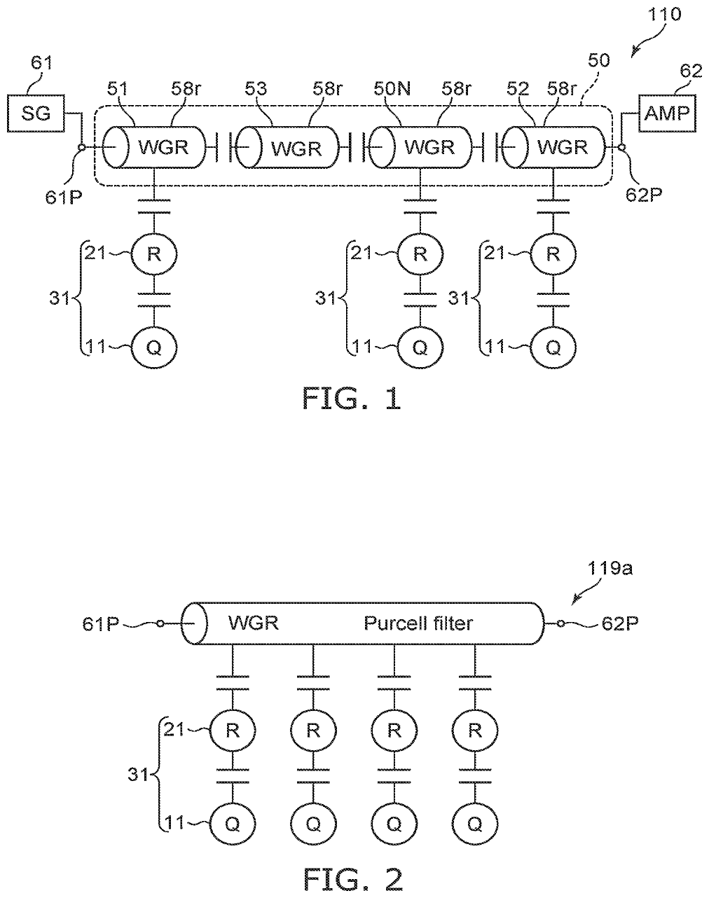

FIG. 1 is a schematic view illustrating an electronic circuit according to a first embodiment.

As shown in FIG. 1, the electronic circuit 110 according to the embodiment includes a band-pass filter 50, multiple first circuits 31, a first port 61P, and a second port 62P.

The band-pass filter 50 includes multiple filter resonators 58r. Two adjacent filter resonators 58r included in the multiple filter resonators 58r are mutually couplable. For example, the two adjacent filter resonators 58r included in the multiple filter resonators 58r are electromagnetically coupled. Electromagnetic coupling includes, for example, at least one of electric field coupling or magnetic field coupling. Electromagnetic coupling may include, for example, at least one of capacitive coupling or inductive coupling. In one example, for example, the two adjacent filter resonators 58r included in the multiple filter resonators 58r are capacitively couplable.

Each of the multiple first circuits 31 includes a first qubit 11 and a first readout resonator 21. The first readout resonator 21 is couplable with the first qubit 11. The first readout resonator 21 is electromagnetically couplable with the first qubit 11.

One of the multiple filter resonators 58r is couplable with the first readout resonator 21 of one of the multiple first circuits 31. Another one of the multiple filter resonators 58r is couplable with the first readout resonator 21 of another one of the multiple first circuits 31.

For example, the multiple filter resonators 58r include a first filter resonator 51, a second filter resonator 52, a third filter resonator 53, etc. In the example, the multiple filter resonators 58r include an Nth filter resonator 50N. “N” is an integer not less than 2. “N” may be an integer not less than 4.

The first filter resonator 51 is couplable with the first port 61P. The second filter resonator 52 is couplable with the second port 62P. The first filter resonator 51 is coupled with the first port 61P. The second filter resonator 52 is coupled with the second port 62P. The third filter resonator 53 is between the first filter resonator 51 and the second filter resonator 52.

According to the embodiment, another filter resonator is located between the filter resonator (in the example, the first filter resonator 51) connected to the first port 61P and the filter resonator (in the example, the second filter resonator 52) connected to the second port 62P. Another filter resonator is, for example, the third filter resonator 53. Another filter resonator is, for example, the Nth filter resonator 50N.

For example, an input signal generator 61 (SG) is included. The first port 61P is configured to receive a signal from the input signal generator 61 and supply the signal to the band-pass filter 50.

For example, an output signal amplifier 62 (AMP) is included. The second port 62P is configured to output the output signal of the band-pass filter 50 to the output signal amplifier 62.

For example, the states of the first qubits 11 included in the multiple first circuits 31 are read out via the first readout resonators 21 and the multiple filter resonators 58r. In a read out operation, the signal from the input signal generator 61 passes through the band-pass filter 50 and is amplified by the output signal amplifier 62.

In the readout operation, information related to multiple states of the first qubit 11 is obtained. The multiple states of the first qubit 11 include, for example, a first state and a second state. For example, the signal phase difference between the first state and the second state is read out. The state of the first qubit 11 is determined thereby. For example, in the calculator, the first state corresponds to one of “0” or “1”. The second state corresponds to the other of “0” or “1”.

According to the embodiment as described above, another filter resonator is located between the filter resonator connected to the first port 61P and the filter resonator connected to the second port 62P. The configuration of a multistage filter is used.

A passband that has a wide bandwidth and uniform characteristics is obtained thereby. On the other hand, a large out-of-band suppression amount is obtained outside the passband. According to the embodiment, for example, a faster readout operation is possible. For example, an electronic circuit that enables high-speed readout can be provided, and an electronic circuit can be provided in which the characteristics can be improved.

In the electronic circuit 110, each of the multiple filter resonators 58r is, for example, a waveguide resonator (WGR). For example, the band-pass filter 50 functions as a Purcell filter. The filter response characteristics of the band-pass filter 50 may be, for example, Chebyshev filter characteristics.

FIG. 2 is a schematic view illustrating an electronic circuit according to a first reference example.

In the electronic circuit 119a of the first reference example as shown in FIG. 2, one waveguide resonator is included and functions as a Purcell filter. One end of the one waveguide resonator is connected with the first port 61P. The other end of the one waveguide resonator is connected with the second port 62P. In the electronic circuit 119a, the one waveguide resonator is coupled with the multiple first circuits 31.

In such an electronic circuit 119a, the multiple first qubits 11 that are included in the multiple first circuits 31 are collectively read out. In the electronic circuit 119a, for example, a Lorentz-type filter effect of one stage is obtained. In the electronic circuit 119a, the passband of the waveguide resonator is relatively narrow. In the electronic circuit 119a, it is difficult to obtain a wide passband with uniform characteristics, and it is difficult to include many qubits. In the electronic circuit 119a, the out-of-band suppression amount outside the passband is small, and it is difficult to increase the readout speed.

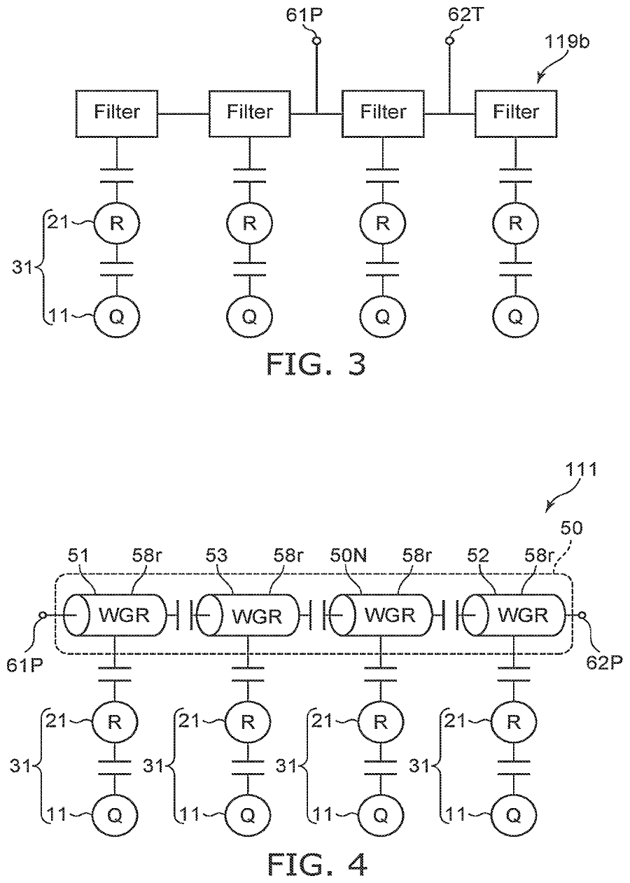

FIG. 3 is a schematic view illustrating an electronic circuit according to a second reference example.

As shown in FIG. 3, multiple filters are included in the electronic circuit 119b of the second reference example. The first circuits 31 are respectively coupled to the multiple filters. In the electronic circuit 119b, the first port 61P is located at one end of one of the multiple filters; and the second port 62P is located at the other end of the one of the multiple filters.

In such an electronic circuit 119b, the states of the multiple first qubits 11 are separately read out. The readout characteristics of the states of the multiple first qubits 11 are nonuniform.

In contrast, according to the embodiment, a passband that has a wide bandwidth and uniform characteristics is obtained, and the states of the multiple first qubits 11 are collectively read out. It is possible to read out many qubits.

In the example as shown in FIG. 1, one first readout resonator 21 is coupled to the first filter resonator 51. Another one first readout resonator 21 is coupled to the second filter resonator 52. The first readout resonator 21 is not coupled to the third filter resonator 53. Another first readout resonator 21 is coupled to the Nth filter resonator 50N. According to the embodiment, various modifications are possible as to which of the filter resonators are coupled with the first readout resonators 21.

In the example shown in FIG. 1, the first filter resonator 51 is at the end of the band-pass filter 50. The second filter resonator 52 is at the other end of the band-pass filter 50. The first filter resonator 51 is the one of the multiple filter resonators 58r (the filter resonator connected with the first port 61P). The second filter resonator 52 is the other one of the multiple filter resonators 58r (the filter resonator connected with the first port 61P).

According to the embodiment, the filter resonator that is connected with the first port 61P may not be at the end of the band-pass filter 50. The filter resonator that is connected with the second port 62P may not be at the other end of the band-pass filter 50.

Several examples of the electronic circuit according to the embodiment will now be described. The input signal generator 61 and the output signal amplifier 62 are not illustrated in the following drawings.

FIG. 4 is a schematic view illustrating an electronic circuit according to the first embodiment.

In the electronic circuit 111 according to the embodiment as shown in FIG. 4, the multiple filter resonators 58r are respectively couplable with the first readout resonators 21 included in the multiple first circuits 31. For example, four filter resonators 58r are respectively coupled with the first readout resonators 21.

Homogeneous characteristics are easily obtained in the electronic circuit 111. The same design is applicable to the multiple filter resonators 58r and the multiple first circuits 31. Good manufacturability is easily obtained thereby.

Examples of characteristics of the electronic circuit will now be described.

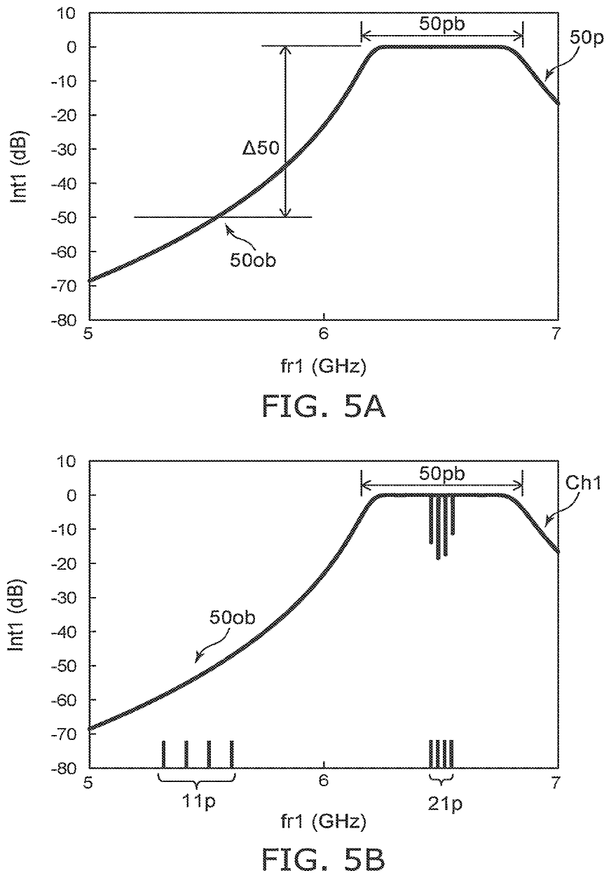

FIGS. 5A and 5B are graphs illustrating characteristics of the electronic circuit according to the first embodiment.

In these figures, the horizontal axis is a frequency fr1 (GHz). In these figures, the vertical axis is a signal intensity Intl (dB).

FIG. 5A illustrates a transmission characteristic 50p of the band-pass filter 50 of the electronic circuit 111. A wide passband 50pb is obtained as shown in FIG. 5A. On the other hand, an out-band suppression Δ50 is large in an out-of-passband region 50ob. In the example, the out-band suppression Δ50 is about 50 dB.

FIG. 5B illustrates a transmission characteristic Ch1 between the first port 61P and the second port 62P of the electronic circuit 111. In the example, the number of the multiple first circuits 31 is 4. FIG. 5B illustrates frequencies 11p of four first qubits 11 and frequencies 21p of four first readout resonators 21.

The resonant frequency of the first readout resonator 21 is within the passband 50pb of the band-pass filter 50. The resonant frequency of the first qubit 11 is in the out-of-passband region 50ob of the band-pass filter 50.

The resonant frequency of the first readout resonator 21 can pass through the band-pass filter 50 with low loss. The resonant frequency of the first qubit 11 substantially does not pass through the band-pass filter 50. For example, the frequency change of the first readout resonator 21 corresponding to the state change of the first qubit 11 can be measured while suppressing the decay of the first qubit 11.

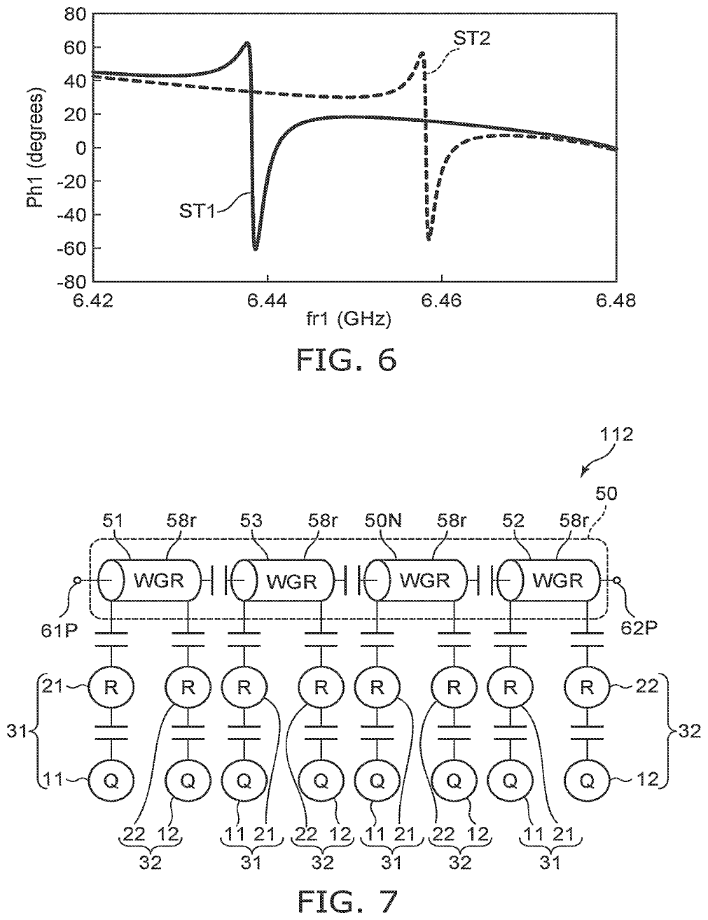

FIG. 6 is a graph illustrating characteristics of the electronic circuit according to the first embodiment.

The horizontal axis of FIG. 6 is the frequency fr1 (GHz). The vertical axis of FIG. 6 is a phase Ph1 (degrees). FIG. 6 illustrates the pass phase between the first port 61P and the second port 62P for the first state ST1 and the second state ST2 of the first qubit 11. As shown in FIG. 6, the phases Ph1 are different at the same frequency because the frequency of the first readout resonator 21 changes between the two states.

For example, there is a trade-off relationship between the readout speed and the qubit life of the multiple states of the qubit. According to the embodiment, the upper limit of the product of the read speed and the qubit life can be increased. For example, the large out-band suppression Δ50 makes a faster readout operation possible.

For example, the coupling strength between the first qubit 11 and the first readout resonator 21 is taken as “g”. The difference between the resonant frequency of the first qubit 11 and the resonant frequency of the first readout resonator 21 corresponds to detuning Δ. A “Δ²/g²”-fold boost effect is obtained by the first readout resonator 21.

For example, an out-band suppression Δ50-fold boost effect is obtained by the band-pass filter 50.

According to the embodiment, for example, the large out-band suppression Δ50 makes a faster readout operation possible.

According to the embodiment, the absolute value of the difference between the maximum value and minimum value of the resonant frequencies of the multiple filter resonators 58r is not more than 1% of the width of the passband 50pb. For example, a general filter function form can be provided because the resonant frequencies of the multiple filter resonators 58r are homogeneous. For example, the design degree of freedom of the electronic circuit is increased.

FIG. 7 is a schematic view illustrating an electronic circuit according to the first embodiment.

As shown in FIG. 7, the electronic circuit 112 according to the embodiment further includes multiple second circuits 32. Each of the multiple second circuits 32 includes a second qubit 12 and a second readout resonator 22. The second readout resonator 22 is couplable with the second qubit 12.

In the electronic circuit 112, the multiple filter resonators 58r are respectively couplable with the first readout resonators 21 included in the multiple first circuits 31. The multiple filter resonators 58r are respectively couplable with the second readout resonators 22 included in the multiple second circuits 32.

Thus, in the electronic circuit 112, each of the multiple filter resonators 58r is coupled to multiple readout resonators.

In the electronic circuit 112, for example, homogeneous characteristics are obtained. A smaller surface area is possible by coupling multiple readout resonators to one filter resonator 58r.

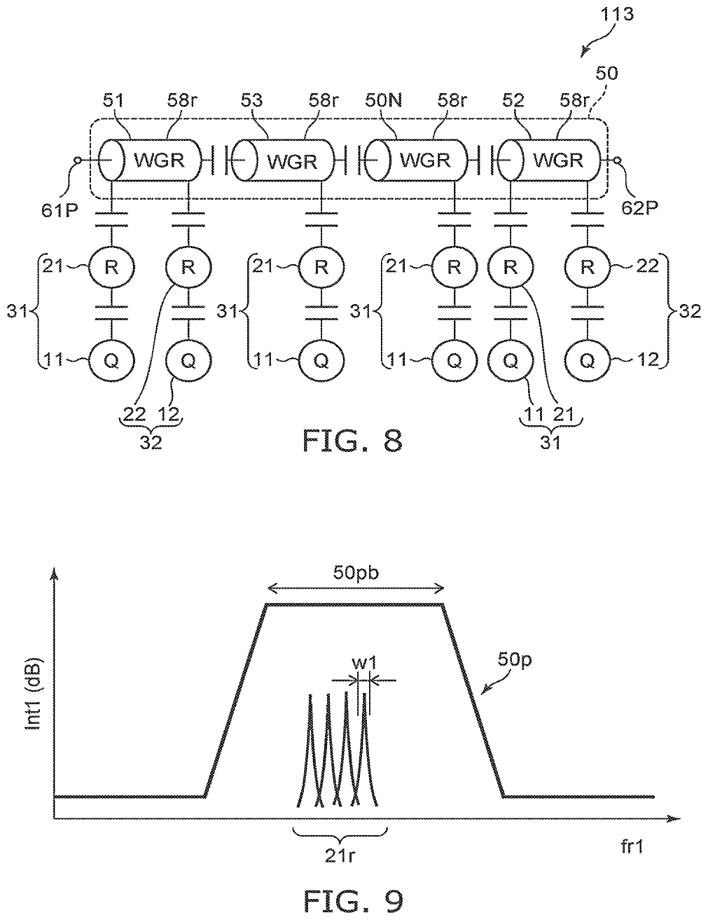

FIG. 8 is a schematic view illustrating an electronic circuit according to the first embodiment.

As shown in FIG. 8, the electronic circuit 113 according to the embodiment includes the multiple first circuits 31 and the second circuit 32. In the example as well, the second circuit 32 includes the second qubit 12, and the second readout resonator 22 that is couplable with the second qubit 12. One of the multiple filter resonators 58r (e.g., the first filter resonator 51) is couplable with the first and second readout resonators 21 and 22. In the example, the second filter resonator 52 is couplable with the first and second readout resonators 21 and 22.

On the other hand, another one of the multiple filter resonators 58r (e.g., the third filter resonator 53 or the Nth filter resonator 50N) is couplable with the first readout resonator 21 but is not coupled with the second readout resonator 22. The other one of the multiple filter resonators 58r (e.g., the third filter resonator 53 or, the Nth filter resonator 50N) is not coupled with a readout resonator other than the first readout resonator of the other one of the multiple filter resonators 58r.

In the electronic circuit 113, the number of coupled readout resonators is different between the multiple filter resonators 58r. The control degree of freedom of the characteristics is increased. For example, the pattern arrangement degree of freedom is increased.

In the example of the electronic circuit 113, the second circuit 32 may be considered to be equivalent to the first circuit 31. In such a case, the electronic circuit 113 may have the following configuration. The electronic circuit 113 includes the band-pass filter 50 and the multiple first circuits 31. The band-pass filter 50 includes the multiple filter resonators 58r. Two adjacent filter resonators 58r included in the multiple filter resonators 58r are mutually couplable. Each of the multiple first circuits 31 includes the first qubit 11, and the first readout resonator 21 that is couplable with the first qubit 11. One of the multiple filter resonators 58r is couplable with the first readout resonator 21 of one of the multiple first circuits 31. Another one of the multiple filter resonators 58r is couplable with the first readout resonator 21 of another one of the multiple first circuits 31. The number of the first readout resonators 21 coupled to the one of the multiple filter resonators 58r is different from the number of the first readout resonators 21 coupled to the other one of the multiple filter resonators 58r.

FIG. 9 is a schematic view illustrating characteristics of the electronic circuit according to the first embodiment.

The horizontal axis of FIG. 9 is the frequency fr1. The vertical axis of FIG. 9 is the signal intensity Intl (dB). FIG. 9 illustrates the transmission characteristic 50p of the band-pass filter 50 and a resonance characteristic 21r of the first readout resonator 21. In the example, the number of the multiple first readout resonators 21 is 4. The number of the multiple first circuits 31 is 4.

As shown in FIG. 9, the width of the passband 50pb is not less than the product of a resonant frequency line width w1 of the first readout resonator 21 and the number of the multiple first circuits 31 (in the example, four). The signal of the multiple first readout resonators 21 can stably pass through the band-pass filter 50 with low loss.

The width of the passband 50pb corresponds to the full width at half maximum (a 3 dB bandwidth) of the characteristic of the passband 50pb. For example, the resonant frequency line width w1 corresponds to the full width at half maximum of the resonant frequency characteristic.

According to the embodiment, many first readout resonators 21 of different frequencies can be within the passband 50pb of the band-pass filter. For example, scalability by frequency multiplexing is obtained.

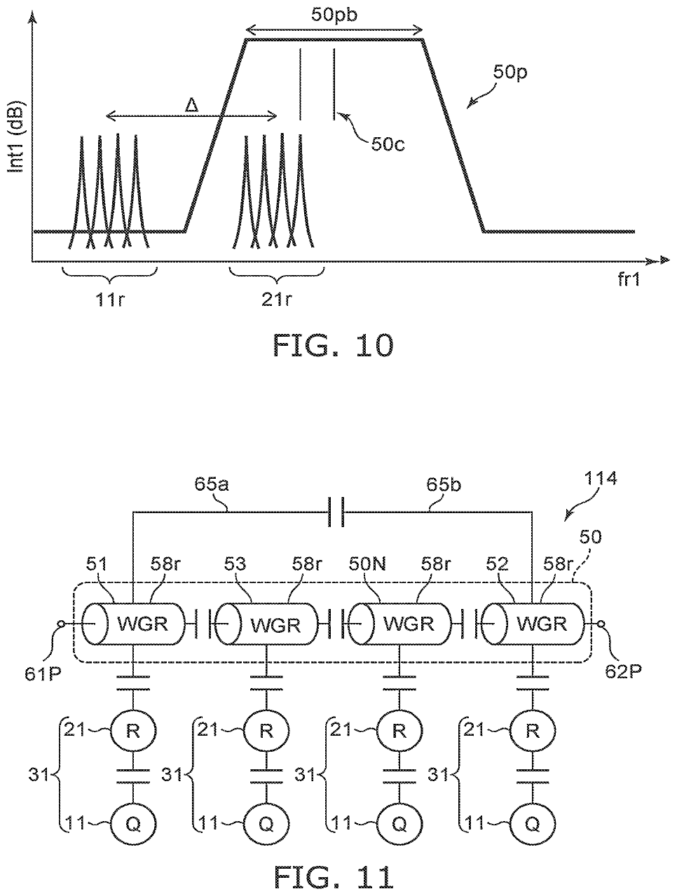

FIG. 10 is a schematic view illustrating characteristics of the electronic circuit according to the first embodiment.

The horizontal axis of FIG. 10 is the frequency fr1. The vertical axis of FIG. 10 is the signal intensity Intl (dB). FIG. 10 illustrates the transmission characteristic 50p of the band-pass filter 50, the resonance characteristic 21r of the first readout resonator 21, and a resonance characteristic 11r of the first qubit 11. In the example, the number of the multiple first readout resonators 21 is 4. The number of the multiple first circuits 31 is 4.

According to the embodiment as shown in FIG. 10, the frequency fr1 of the resonance characteristic 21r of the first readout resonator 21 may be separated from a center frequency 50c of the passband 50pb. For example, high design freedom is obtained for the difference between the frequency fr1 of the resonance characteristic 11r of the first qubit 11 and the frequency fr1 of the resonance characteristic 21r of the first readout resonator 21 (e.g., the detuning A). For example, the large detuning A makes it easier to downsize the electronic circuit 110.

FIG. 11 is a schematic view illustrating an electronic circuit according to the first embodiment.

In the electronic circuit 114 according to the embodiment as shown in FIG. 11, two non-adjacent filter resonators 58r included in the multiple filter resonators 58r are couplable mutually. For example, at least a portion of the multiple filter resonators 58r is couplable in a ring configuration. Otherwise, the configuration of the electronic circuit 114 may be similar to the configurations of the electronic circuits 110 to 113. In the electronic circuit 114, for example, an attenuation pole can be formed in the out-of passband region 50ob. A larger out-band suppression Δ50 is obtained.

For example, the first filter resonator 51 and the second filter resonator 52 that are non-adjacent are couplable by a conductive member 65a and a conductive member 65b.

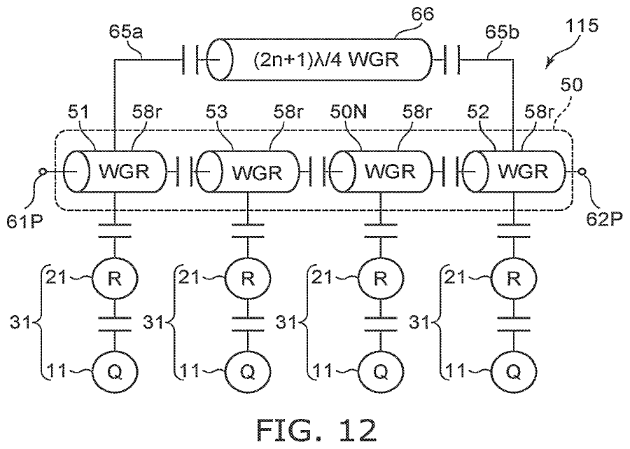

FIG. 12 is a schematic view illustrating an electronic circuit according to the first embodiment.

As shown in FIG. 12, the electronic circuit 115 according to the embodiment includes a first waveguide 66. Otherwise, the configuration may be similar to the configurations of the electronic circuits 110 to 114.

An end portion of the first waveguide 66 is couplable with the one of the two non-adjacent filter resonators 58r (in the example, the first filter resonator 51). The other end portion of the first waveguide 66 is couplable with the other of the two non-adjacent filter resonators 58r (in the example, the second filter resonator 52). The length of the first waveguide 66 is substantially not less than 0.9 times and not more than 1.1 times an odd multiple ((2n+1) times) of ¼ of a wavelength k corresponding to the center frequency 50c of the passband 50pb of the band-pass filter 50. “n” is an integer not less than 0. For example, “cross-coupling” of good and realistic characteristics is obtained.

In the electronic circuits 110 to 115, the length of each of the multiple filter resonators 58r may be, for example, substantially λ/2. The length of each of the multiple filter resonators 58r may be, for example, not less than 0.9 times and not more than 1.1 times λ/2. For example, each of the multiple filter resonators 58r may be a half-wavelength waveguide resonator.

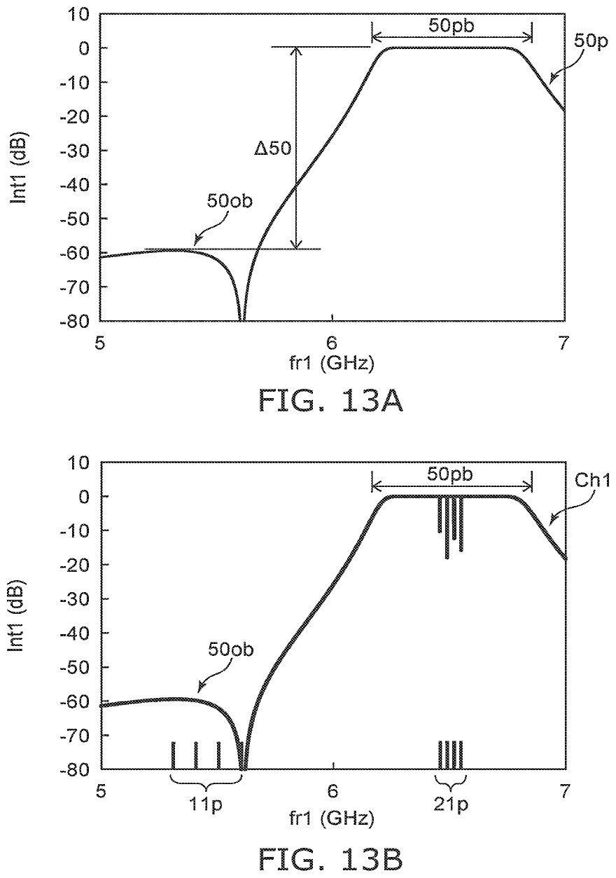

FIGS. 13A and 13B are graphs illustrating characteristics of the electronic circuit according to the first embodiment.

In these figures, the horizontal axis is the frequency fr1 (GHz). In these figures, the vertical axis is the signal intensity Intl (dB). FIG. 13A illustrates the transmission characteristic 50p of the band-pass filter 50 of the electronic circuit 114. As shown in FIG. 13A, a wide passband 50pb is obtained. On the other hand, the out-band suppression Δ50 in the out-of-passband region 50ob is large. In the example, the out-band suppression Δ50 is about 58 dB.

FIG. 13B illustrates the transmission characteristic Ch1 between the first port 61P and the second port 62P of the electronic circuit 114. In the example, the number of the multiple first circuits 31 is 4. FIG. 13B illustrates the frequency 11p of the four first qubits 11 and the frequency 21p of the four first readout resonators 21.

The resonant frequency of the first readout resonator 21 is within the passband 50pb of the band-pass filter 50. The resonant frequency of the first qubit 11 is in the out-of-passband region 50ob of the band-pass filter 50.

The resonant frequency of the first readout resonator 21 can pass through the band-pass filter 50 with low loss. The resonant frequency of the first qubit 11 substantially does not pass through the band-pass filter 50. For example, the frequency change of the first readout resonator 21 corresponding to the state change of the first qubit 11 can be measured while suppressing the decay of the first qubit 11.

In the electronic circuit 115 illustrated in FIG. 12 as well, characteristics similar to the characteristics illustrated in FIGS. 13A and 13B are obtained.

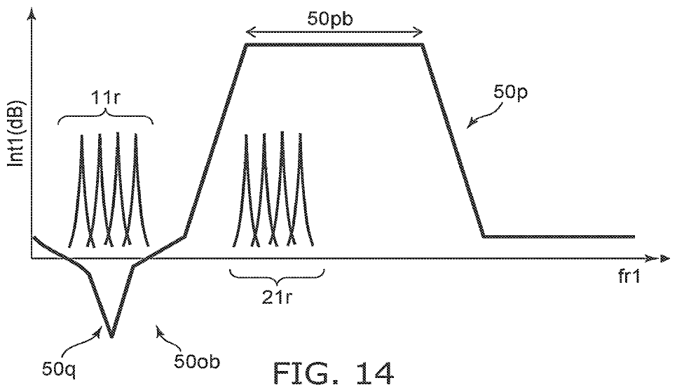

FIG. 14 is a schematic view illustrating characteristics of the electronic circuit according to the first embodiment.

The horizontal axis of FIG. 14 is the frequency fr1. The vertical axis of FIG. 14 is the signal intensity Intl. FIG. 14 illustrates the transmission characteristic of the band-pass filter 50 of FIG. 11 or the transmission characteristic of the band-pass filter 50 of FIG. 12.

As shown in FIG. 14, the transmission characteristic 50p of the band-pass filter 50 includes the passband 50pb and the out-of-passband region 50ob. An attenuation pole 50q is in the out-of-passband region 50ob of the band-pass filter 50. The frequency fr1 of the resonance characteristic 11r of the first qubit 11 overlaps at least a portion of the frequency band of the attenuation pole 50q. The out-band suppression Δ50 can be increased. For example, faster readout is possible.

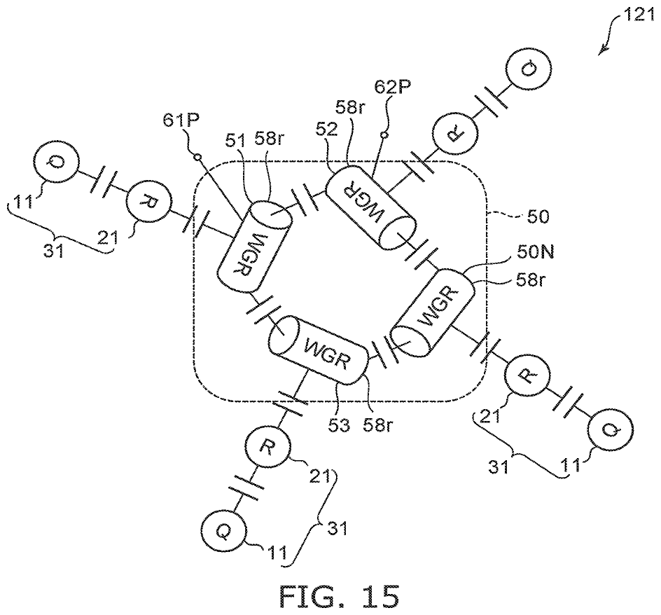

FIG. 15 is a schematic view illustrating an electronic circuit according to the first embodiment.

As shown in FIG. 15, the electronic circuit 121 according to the embodiment includes the band-pass filter 50 and the multiple first circuits 31. The band-pass filter 50 includes the multiple filter resonators 58r. Two adjacent filter resonators 58r included in the multiple filter resonators 58r are mutually couplable. The multiple filter resonators 58r are arranged in a ring configuration. At least a portion of the multiple filter resonators 58r may be arranged in a ring configuration.

Each of the multiple first circuits 31 includes the first qubit 11, and the first readout resonator 21 that is couplable with the first qubit 11. One of the multiple filter resonators 58r is couplable with the first readout resonator 21 of one of the multiple first circuits 31.

In the electronic circuit 121 as well, the characteristics illustrated in FIG. 14 are obtained. For example, the attenuation pole 50q is located in the out-of-passband region 50ob of the band-pass filter 50. The out-band suppression Δ50 can be increased. For example, faster readout is possible.

In the electronic circuit 121, the first port 61P and the second port 62P may be connected to any two of the multiple filter resonators 58r.

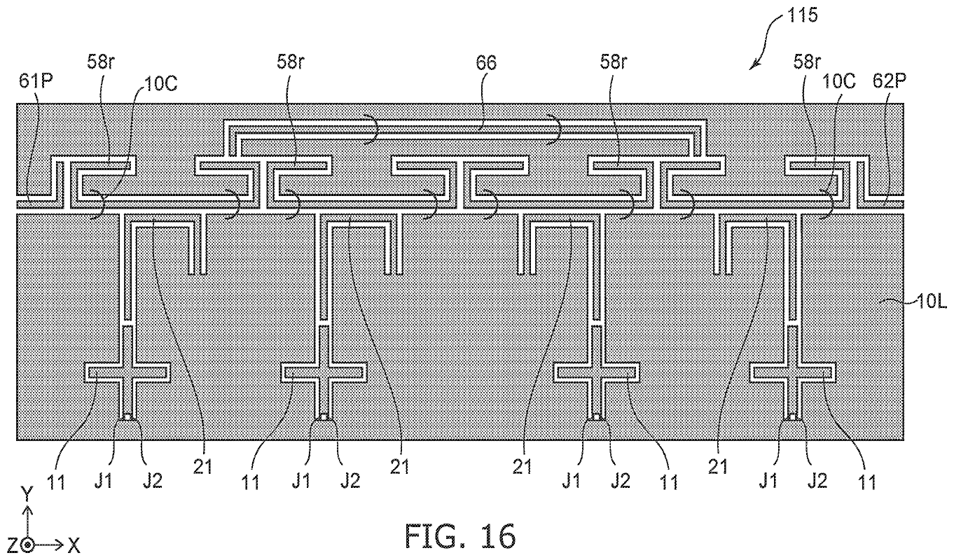

FIG. 16 is a schematic plan view illustrating an electronic circuit according to the first embodiment.

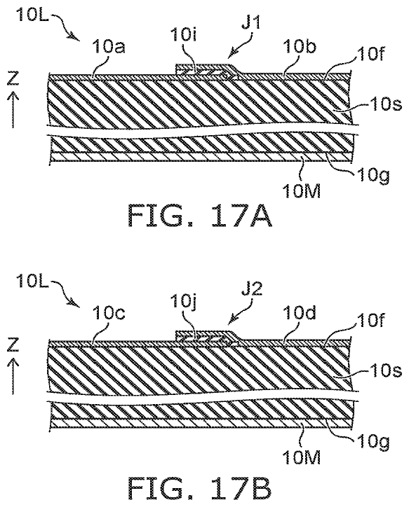

FIG. 16 shows one example of the electronic circuit 115. For example, the multiple filter resonators 58r, the multiple first qubits 11, the multiple first readout resonators 21, etc., can be formed from a conductive layer 10L. For example, the conductive layer 10L may be located on a substrate 10s (see FIGS. 17A and 17B below). The substrate 10s may be, for example, a dielectric substrate. The substrate 10s may include, for example, at least one selected from the group consisting of sapphire and silicon. For example, planar circuits that are coplanar may be formed from the conductive layer 10L.

Several of the multiple conductive layers 10L are located around the resonators, the signal lines, etc. Several of the multiple conductive layers 10L are used as ground layers. The multiple conductive layers 10L that correspond to ground layers may be electrically connected to each other by connection conductive members 10C. The connection conductive members 10C may include, for example, wires, etc. The connection conductive members 10C may include at least a portion of a base conductive member 10M described below (see FIGS. 17A and 17B below).

In the example, the first waveguide 66 that is formed from the conductive layer 10L also is included. As shown in FIG. 16, multiple Josephson junctions (a first Josephson junction J1, a second Josephson junction J2, etc.) are included in each of the multiple first qubits 11. The current path that includes the multiple Josephson junctions is a closed loop. A dc-SQUID (superconducting quantum interference device) is formed of the current path. For example, the space that is surrounded with the current path including the multiple Josephson junctions corresponds to a SQUID loop. For example, the multiple first qubits 11 correspond to transmon resonators.

FIGS. 17A and 17B are schematic cross-sectional views illustrating portions of the electronic circuit according to the first embodiment.

FIG. 17A illustrates the first Josephson junction J1. For example, a first conductive layer 10a and a second conductive layer 10b are located on a first surface 10f of the substrate 10s. A first insulating layer 10i is located between a portion of the first conductive layer 10a and a portion of the second conductive layer 10b. The first Josephson junction J1 is formed from the first insulating layer 10i and these conductive layers.

FIG. 17B illustrates the second Josephson junction J2. For example, a third conductive layer 10c and a fourth conductive layer 10d are located on the first surface 10f of the substrate 10s. A second insulating layer 10j is located between a portion of the third conductive layer 10c and a portion of the fourth conductive layer 10d. The second Josephson junction J2 is formed from the second insulating layer 10j and these conductive layers.

The third conductive layer 10c may be connected with or continuous with one of the first conductive layer 10a or the second conductive layer 10b. The fourth conductive layer 10d may be connected with or continuous with the other of the first conductive layer 10a or the second conductive layer 10b. The second insulating layer 10j may be continuous with the first insulating layer 10i.

The direction from a portion of the first conductive layer 10a toward a portion of the second conductive layer 10b is taken as a Z-axis direction. One direction perpendicular to the Z-axis direction is taken as an X-axis direction. A direction perpendicular to the Z-axis direction and the X-axis direction is taken as a Y-axis direction. The first conductive layer 10a, the second conductive layer 10b, the third conductive layer 10c, and the fourth conductive layer 10d correspond to portions of the conductive layer 10L. The conductive layer 10L is along the X-Y plane (see FIG. 16).

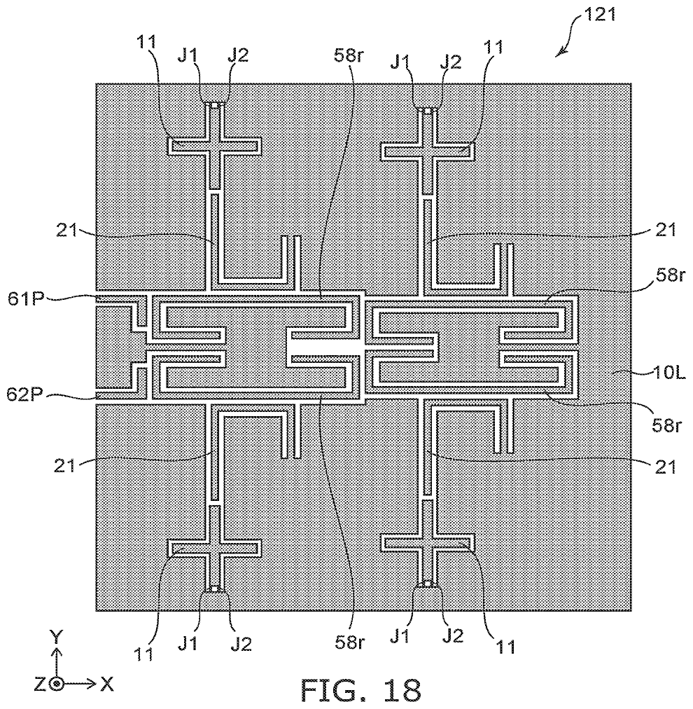

FIG. 18 is a schematic plan view illustrating an electronic circuit according to the first embodiment.

FIG. 18 shows one example of the electronic circuit 121. For example, the multiple filter resonators 58r, the multiple first qubits 11, the multiple first readout resonators 21, etc., can be formed from the conductive layer 10L. The multiple filter resonators 58r are arranged in a ring configuration in one plane (in the X-Y plane).

In the electronic circuits 115 and 121, a transmon qubit that includes multiple Josephson junctions is used as each of the multiple first qubits 11. According to the embodiment, a transmon qubit that includes one Josephson junction is applicable to at least one of the multiple first qubits 11.

According to the embodiment, the base conductive member 10M may be located at a second surface 10g of the substrate 10s. The first surface 10f is between the second surface 10g and the conductive layer 10L. The second surface 10g is between the base conductive member 10M and the first surface 10f. The second surface 10g is the surface at the side opposite to the first surface 10f. For example, the base conductive member 10M may be set to a fixed potential. The base conductive member 10M may be, for example, a ground plane. The second surface 10g may contact a conductive housing. The base conductive member 10M may be at least a portion of a conductive housing. The base conductive member 10M and a portion of the conductive layer 10L may be electrically connected by a connection member. For example, the connection member may be a via extending through the substrate 10s. A conductive housing and a portion of the conductive layer 10L may be electrically connected by a connection member. The connection member may be, for example, a conductive wire.

### Second Embodiment

A second embodiment relates to a calculator.

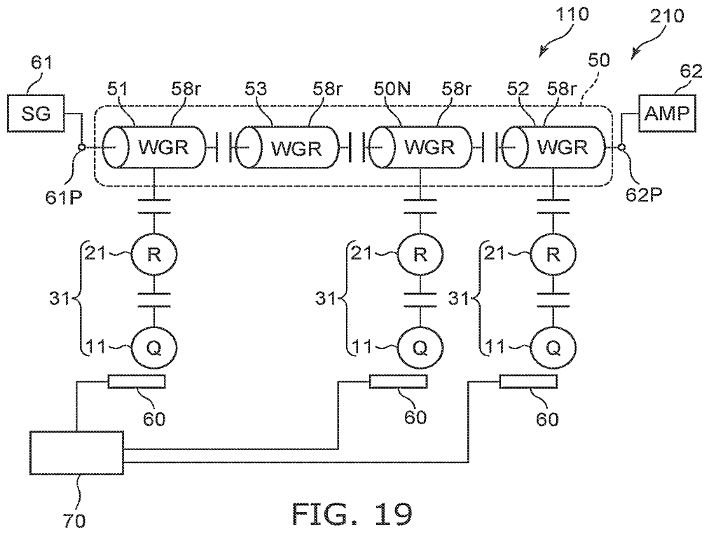

FIG. 19 is a schematic view illustrating the calculator according to the second embodiment.

As shown in FIG. 19, the calculator 210 according to the embodiment includes the electronic circuit according to the first embodiment (in the example, the electronic circuit 110) and a controller 70. The controller 70 is configured to control the state of the first qubit. For example, a control conductive member 60 is located in the electronic circuit or the calculator. The control conductive member 60 may be located at the vicinity of the first qubit 11. The controller 70 supplies an alternating current to the control conductive member 60. The electromagnetic field that is generated from the control conductive member 60 is applied to the first qubit 11. The controller 70 is configured to control the state of the first qubit by controlling the alternating current. A calculation operation is possible in the calculator 210. For example, the calculator 210 may include the first port 61P and the second port 62P.

According to the embodiment, for example, a single “qubit-readout resonator pair” is connected to the resonator. A filter in which multiple resonators are coupled is included. For example, the bit states of all of the qubits are collectively read out. A multistage filter configuration is applied. A wide and flat passband and a large out-band suppression are obtained thereby. For example, a strong Purcell effect is obtained. For example, readout performance that is homogenized for each qubit is obtained. For example, the scalability can be improved by collectively reading out all qubits.

According to embodiments, for example, an electronic circuit can be provided in which faster readout of the qubit information is possible. According to embodiments, for example, a calculator can be provided in which complex calculations are possible. According to embodiments, for example, a calculator can be provided in which faster calculations are possible.

Embodiments may include the following configurations (e.g., technological proposals).

### Configuration 1

An electronic circuit, comprising:
a band-pass filter including a plurality of filter resonators, two adjacent filter resonators included in the plurality of filter resonators being mutually couplable;
a plurality of first circuits, each of the plurality of first circuits including a first qubit and a first readout resonator, the first readout resonator being couplable with the first qubit, one of the plurality of filter resonators being couplable with the first readout resonator of one of the plurality of first circuits, another one of the plurality of filter resonators being couplable with the first readout resonator of another one of the plurality of first circuits;
a first port; and
a second port,
the plurality of filter resonators including a first filter resonator, a second filter resonator, and a third filter resonator,
the first filter resonator being couplable with the first port,
the second filter resonator being couplable with the second port,
the third filter resonator being between the first filter resonator and the second filter resonator.

### Configuration 2

The electronic circuit according to Configuration 1, wherein
the first port is configured to receive a signal from an input signal generator and supply the signal to the band-pass filter, and
the second port is configured to output an output signal of the band-pass filter to an output signal amplifier.

### Configuration 3

The electronic circuit according to Configuration 1 or 2, wherein
the first filter resonator is at an end of the band-pass filter, and
the second filter resonator is at another end of the band-pass filter.

### Configuration 4

The electronic circuit according to Configuration 1, wherein
the first filter resonator is the one of the plurality of filter resonators.

### Configuration 5

The electronic circuit according to Configuration 4, wherein
the second filter resonator is the other one of the plurality of filter resonators.

### Configuration 6

The electronic circuit according to Configuration 1, wherein
the plurality of filter resonators is respectively couplable with the first readout resonators included in the plurality of first circuits.

### Configuration 7

The electronic circuit according to Configuration 6, further comprising:
a plurality of second circuits,
each of the plurality of second circuits including a second qubit and a second readout resonator,
the second readout resonator being couplable with the second qubit,
the plurality of filter resonators being respectively couplable with the second readout resonators included in the plurality of second circuits.

### Configuration 8

The electronic circuit according to any one of Configurations 1 to 5, further comprising:
a second circuit,
the second circuit including a second qubit and a second readout resonator,
the second readout resonator being couplable with the second qubit,
the one of the plurality of filter resonators also being couplable with the second readout resonator.

### Configuration 9

The electronic circuit according to any one of Configurations 1 to 5, further comprising:
a second circuit,
the second circuit including a second qubit and a second readout resonator,
the second readout resonator being couplable with the second qubit,
the one of the plurality of filter resonators also being couplable with the second readout resonator,
the other one of the plurality of filter resonators not being coupled with a readout resonator other than the first readout resonator of the other one of the plurality of filter resonators.

### Configuration 10

The electronic circuit according to any one of Configurations 1 to 9, wherein
a resonant frequency of the first readout resonator is within a passband of the band-pass filter, and
a resonant frequency of the first qubit is out-of passband region of the band-pass filter.

### Configuration 11

The electronic circuit according to Configuration 10, wherein
an absolute value of a difference between a maximum value and a minimum value of resonant frequencies of the plurality of filter resonators is not more than 1% of a width of the passband.

### Configuration 12

The electronic circuit according to Configuration 10, wherein
a width of the passband is not less than a product of a resonant frequency line width of the first readout resonator and a number of the plurality of first circuits.

### Configuration 13

The electronic circuit according to Configuration 10, wherein
the resonant frequency of the first readout resonator is separated from a center frequency of the passband.

### Configuration 14

The electronic circuit according to any one of Configurations 1 to 9, wherein
at least a portion of the plurality of filter resonators is couplable in a ring configuration.

### Configuration 15

The electronic circuit according to Configuration 14, further comprising:
a first waveguide,
an end portion of the first waveguide being couplable with one of two non-adjacent filter resonators,
another end portion of the first waveguide being couplable with another of the two non-adjacent filter resonators,
a length of the first waveguide being not less than 0.9 times and not more than 1.1 times an odd multiple of ¼ of a wavelength corresponding to a center frequency of a passband of the band-pass filter.

### Configuration 16

An electronic circuit, comprising:
a band-pass filter including a plurality of filter resonators, two adjacent filter resonators included in the plurality of filter resonators being mutually couplable, at least a portion of the plurality of filter resonators being arranged in a ring configuration; and
a plurality of first circuits, each of the plurality of first circuits including a first qubit and a first readout resonator, the first readout resonator being couplable with the first qubit,
one of the plurality of filter resonators being couplable with the first readout resonator of one of the plurality of first circuits.

### Configuration 17

The electronic circuit according to any one of Configurations 14 to 16, wherein
an attenuation pole is out-of-passband region of the band-pass filter, and
a resonant frequency of the first qubit overlaps at least a portion of a frequency band of the attenuation pole.

### Configuration 18

The electronic circuit according to any one of Configurations 1 to 17, wherein
each of the plurality of filter resonators is a half-wavelength waveguide resonator.

### Configuration 19

An electronic circuit, comprising:
a band-pass filter including a plurality of filter resonators, two adjacent filter resonators included in the plurality of filter resonators being mutually couplable; and
a plurality of first circuits, each of the plurality of first circuits including a first qubit and a first readout resonator, the first readout resonator being couplable with the first qubit,
one of the plurality of filter resonators being couplable with the first readout resonator of one of the plurality of first circuits,
another one of the plurality of filter resonators being couplable with the first readout resonator of another one of the plurality of first circuits,
a number of the first readout resonators coupled to the one of the plurality of filter resonators being different from a number of the first readout resonators coupled to the other one of the plurality of filter resonators.

### Configuration 20

A calculator, comprising:
the electronic circuit according to any one of Configurations 1 to 19; and
a controller configured to control a state of the first qubit.

According to embodiments, an electronic circuit and a calculator can be provided in which the characteristics can be improved.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in electronic circuits and calculators such as band-pass filters, filter resonators, circuits, qubits, resonators, waveguides, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all electronic circuits, and calculators practicable by an appropriate design modification by one skilled in the art based on the electronic circuits, and the calculators described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An electronic circuit, comprising:
a band-pass filter including a plurality of filter resonators, two adjacent filter resonators included in the plurality of filter resonators being mutually couplable;
a plurality of first circuits, each of the plurality of first circuits including a first qubit and a first readout resonator, the first readout resonator being couplable with the first qubit, one of the plurality of filter resonators being couplable with the first readout resonator of one of the plurality of first circuits, another one of the plurality of filter resonators being couplable with the first readout resonator of another one of the plurality of first circuits;
a first port; and
a second port,
the plurality of filter resonators including a first filter resonator, a second filter resonator, and a third filter resonator,
the first filter resonator being couplable with the first port,
the second filter resonator being couplable with the second port,
the third filter resonator being between the first filter resonator and the second filter resonator.

2. The circuit according to claim 1, wherein
the first port is configured to receive a signal from an input signal generator and supply the signal to the band-pass filter, and
the second port is configured to output an output signal of the band-pass filter to an output signal amplifier.

3. The circuit according to claim 1, wherein
the first filter resonator is at an end of the band-pass filter, and
the second filter resonator is at another end of the band-pass filter.

4. The circuit according to claim 1, wherein
the first filter resonator is the one of the plurality of filter resonators.

5. The circuit according to claim 4, wherein
the second filter resonator is the other one of the plurality of filter resonators.

6. The circuit according to claim 1, wherein
the plurality of filter resonators is respectively couplable with the first readout resonators included in the plurality of first circuits.

7. The circuit according to claim 6, further comprising:
a plurality of second circuits,
each of the plurality of second circuits including a second qubit and a second readout resonator,
the second readout resonator being couplable with the second qubit,
the plurality of filter resonators being respectively couplable with the second readout resonators included in the plurality of second circuits.

8. The circuit according to claim 1, further comprising:
a second circuit,
the second circuit including a second qubit and a second readout resonator,
the second readout resonator being couplable with the second qubit,
the one of the plurality of filter resonators also being couplable with the second readout resonator.

9. The circuit according to claim 1, further comprising:
a second circuit,
the second circuit including a second qubit and a second readout resonator,
the second readout resonator being couplable with the second qubit,
the one of the plurality of filter resonators also being couplable with the second readout resonator,
the other one of the plurality of filter resonators not being coupled with a readout resonator other than the first readout resonator of the other one of the plurality of filter resonators.

10. The circuit according to claim 1, wherein
a resonant frequency of the first readout resonator is within a passband of the band-pass filter, and
a resonant frequency of the first qubit is out-of-passband region of the band-pass filter.

11. The circuit according to claim 10, wherein
an absolute value of a difference between a maximum value and a minimum value of resonant frequencies of the plurality of filter resonators is not more than 1% of a width of the passband.

12. The circuit according to claim 10, wherein
a width of the passband is not less than a product of a resonant frequency line width of the first readout resonator and a number of the plurality of first circuits.

13. The circuit according to claim 10, wherein
the resonant frequency of the first readout resonator is separated from a center frequency of the passband.

14. The circuit according to claim 1, wherein
at least a portion of the plurality of filter resonators is couplable in a ring configuration.

15. The circuit according to claim 14, further comprising:
a first waveguide,
an end portion of the first waveguide being couplable with one of two non-adjacent filter resonators,
another end portion of the first waveguide being couplable with another of the two non-adjacent filter resonators,
a length of the first waveguide being not less than 0.9 times and not more than 1.1 times an odd multiple of ¼ of a wavelength corresponding to a center frequency of a passband of the band-pass filter.

16. An electronic circuit, comprising:
a band-pass filter including a plurality of filter resonators, two adjacent filter resonators included in the plurality of filter resonators being mutually couplable, at least a portion of the plurality of filter resonators being arranged in a ring configuration; and
a plurality of first circuits, each of the plurality of first circuits including a first qubit and a first readout resonator, the first readout resonator being couplable with the first qubit,
one of the plurality of filter resonators being couplable with the first readout resonator of one of the plurality of first circuits.

17. The circuit according to claim 14, wherein
an attenuation pole is out-of-passband region of the band-pass filter, and
a resonant frequency of the first qubit overlaps at least a portion of a frequency band of the attenuation pole.

18. The circuit according to claim 1, wherein
each of the plurality of filter resonators is a half-wavelength waveguide resonator.

19. An electronic circuit, comprising:
a band-pass filter including a plurality of filter resonators, two adjacent filter resonators included in the plurality of filter resonators being mutually couplable; and
a plurality of first circuits, each of the plurality of first circuits including a first qubit and a first readout resonator, the first readout resonator being couplable with the first qubit,
one of the plurality of filter resonators being couplable with the first readout resonator of one of the plurality of first circuits,
another one of the plurality of filter resonators being couplable with the first readout resonator of another one of the plurality of first circuits,
a number of the first readout resonators coupled to the one of the plurality of filter resonators being different from a number of the first readout resonators coupled to the other one of the plurality of filter resonators.

20. A calculator, comprising:
the electronic circuit according to claim 1; and
a controller configured to control a state of the first qubit.
